(19) United States
(12) Patent Application Publication
(10) Pub. No.: US 2014/0161035 A1
(43) Pub. Date: Jun. 12, 2014

(54) COMMUNICATION TERMINAL AND COMMUNICATION METHOD

(71) Applicant: Fujitsu Mobile Communications Limited, Kawasaki-shi (JP)

(72) Inventor: Yuki YOSHIDA, Kawasaki (JP)

(73) Assignee: Fujitsu Mobile Communications Limited, Kawasaki-shi (JP)

(21) Appl. No.: 14/043,945

(22) Filed: Oct. 2, 2013

(30) Foreign Application Priority Data
Dec. 7, 2012 (JP) 2012-268528

(51) Int. Cl. H04B 15/00; H04W 88/06

(52) U.S. Cl. CPC H04B 15/00; H04W 88/06
USPC 370/328

(57) ABSTRACT

An operation monitoring unit monitors whether a WiMax communication unit operates and whether a CDMA communication unit operates. A quality determining unit determines whether the reception quality of the CDMA communication has deteriorated when the WiMax communication and the CDMA communication are simultaneously performed. An interference suppressing unit suppresses the interference in the CDMA communication and caused by the WiMax communication when the reception quality of the CDMA communication has deteriorated.

### CROSS-REFERENCE TO RELATED APPLICATION

This application is based upon and claims the benefit of priority of the prior Japanese Patent Application No. 2012-268528, filed on Dec. 7, 2012, the entire contents of which are incorporated herein by reference.

### FIELD

The embodiments discussed herein are related to a communication terminal and a communication method.

### BACKGROUND

Some communication terminals such as a mobile phone can communicate with each other using different communication systems from each other in recent years. For example, there is a communication terminal that enables either of the communication using a Code Division Multiple Access (CDMA) system (hereinafter, also referred to as the “CDMA communication”) and the communication using a Worldwide Interoperability for Microwave Access (WiMax) system (hereinafter, also referred to as the “WiMax communication”). There are some communication terminals that can communicate with each other using a plurality of communication systems different from each other from among a Global System for Mobile Communication system (GSM (registered trademark)), a Universal Mobile Telecommunications System (UMTS (registered trademark)), a Wireless Fidelity system (Wi-Fi (registered trademark)), a Bluetooth (BT) system (Bluetooth (registered trademark)), and the like in addition to the CDMA communication and the WiMax communication.

Generally, even the communication terminal that enables the communication using a plurality of communication systems has stopped the communication using a communication system during the communication using the other communication system in the past.

Related-art examples are described, for example, in Japanese Laid-open Patent Publication No. 2009-060250, Japanese Laid-open Patent Publication No. 2004-236246, Japanese Laid-open Patent Publication No. 2004-363728, Japanese Laid-open Patent Publication No. 2006-129247, Japanese Laid-open Patent Publication No. 2001-267955 and Japanese Laid-open Patent Publication No. 2005-252604.

However, the need for simultaneous usage of a plurality of different communication systems, for example, the data communication using a communication system during the telephone conversation using the other communication system at a communication terminal has been increasing in these days.

The reception quality can deteriorate, for example, due to the following three causes 1 to 3 when communications using two communication systems are simultaneously performed at a communication terminal.

Cause 1

Interference occurs because a noise in the reception band due to the side lobe components of the transmission wave in a communication system is diffracted to the receiver in the other communication system through the antenna in the other communication system. This causes the desensitization of the receiver in the other communication system. Thus, the reception quality deteriorates. The deterioration of the reception quality due to the noise in the reception band sometimes occurs when the transmission frequency band used in a communication system and the reception frequency band used in the other communication system are relatively near each other.

Cause 2

Interference occurs because the transmission wave in a communication system is diffracted to the receiver in the other communication system through the antenna in the other communication system. This causes the saturation of the Low Noise Amplifier (LNA) and the mixer of the receiver in the other communication system. This causes the desensitization of the receiver. Thus, the reception quality deteriorates.

Cause 3

When interference occurs because the transmission wave in a communication system is diffracted to the receiver in the other communication system through the antenna in the other communication system, the inter modulation distortion components between the transmission wave in a communication system and the transmission wave in the other communication system fall into the reception band of the other communication system. This causes the desensitization of the receiver in the other communication system. Thus, the reception quality deteriorates. The deterioration of the reception quality due to the inter modulation can occur depending on a combination of frequencies even when the transmission frequency band used in a communication system and the reception frequency band used in the other communication system are relatively far away from each other.

To prevent deterioration of the reception quality due to the interference because of the above-mentioned, for example, the isolation between the antennas has been maintained with adjusting the arrangement of the antennas at the design phase in the past.

However, the need for a higher-performance communication terminal highly increases the number of mounted components onto a communication terminal in recent year. This limits the installation locations of the antennas in a communication terminal. Thus, it is difficult to sufficiently maintain the isolation between the antennas in the design phase.

### SUMMARY

According to an aspect of an embodiment, a communication terminal includes a first communication unit that performs a first communication using a first communication system, a second communication unit that performs a second communication using a second communication system different from the first communication system, a determining unit that determines whether a reception quality of the second communication deteriorates when the first communication and the second communication are simultaneously performed, and a suppressing unit that, when the reception quality deteriorates, performs a suppressing process for suppressing an interference in the second communication, the interference being caused by the first communication.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram of an exemplary communication terminal in a first embodiment;

FIG. 2 is a flowchart for describing the process in the communication terminal in the first embodiment;

FIG. 3 is a functional block diagram of an exemplary communication terminal in a second embodiment;

FIG. 4 is a flowchart for describing the process in the communication terminal in the second embodiment;

FIG. 5 is a functional block diagram of an exemplary communication terminal in a third embodiment;

FIG. 6 is a flowchart for describing the process in the communication terminal in the third embodiment;

FIG. 7 is a functional block diagram of an exemplary communication terminal in a fourth embodiment;

FIG. 8 is a flowchart for describing the process in the communication terminal in the fourth embodiment;

FIG. 9 is a functional block diagram of an exemplary communication terminal in a fifth embodiment;

FIG. 10 is a flowchart for describing the process in the communication terminal in the fifth embodiment;

FIG. 11 is a functional block diagram of an exemplary communication terminal in a sixth embodiment;

FIG. 12 is a flowchart for describing the process in the communication terminal in the sixth embodiment;

FIG. 13 is a view for describing the process in a communication terminal in an seventh embodiment; and

FIG. 14 is a view of an exemplary hardware configuration of each of the communication terminals.

### DESCRIPTION OF EMBODIMENTS

Preferred embodiments of the present invention will be explained with reference to accompanying drawings. Note that the communication terminal and communication method disclosed in the present application are not limited to the embodiments to be described below. Further, the configurations having the same functions and the processes having the same procedures in the embodiments are denoted with the same reference signs. The overlapping descriptions will be omitted.

Note that an example in which a first communication system is the WiMax system and a second communication system is the CDMA system will be described hereinafter. However, the first communication system is not limited to the WiMax system and the second communication system is not limited to the CDMA system. The first communication system and the second communication system only have to be different from each other. In addition to the WiMax system and the CDMA system, a GSM system (GSM (registered trademark)), a UMTS System, a WiFi system (Wi-Fi (registered trademark)), a BT system (Bluetooth (registered trademark)), and the like can be adopted as the first communication system and the second communication.

### First Embodiment

### Configuration of Communication Terminal

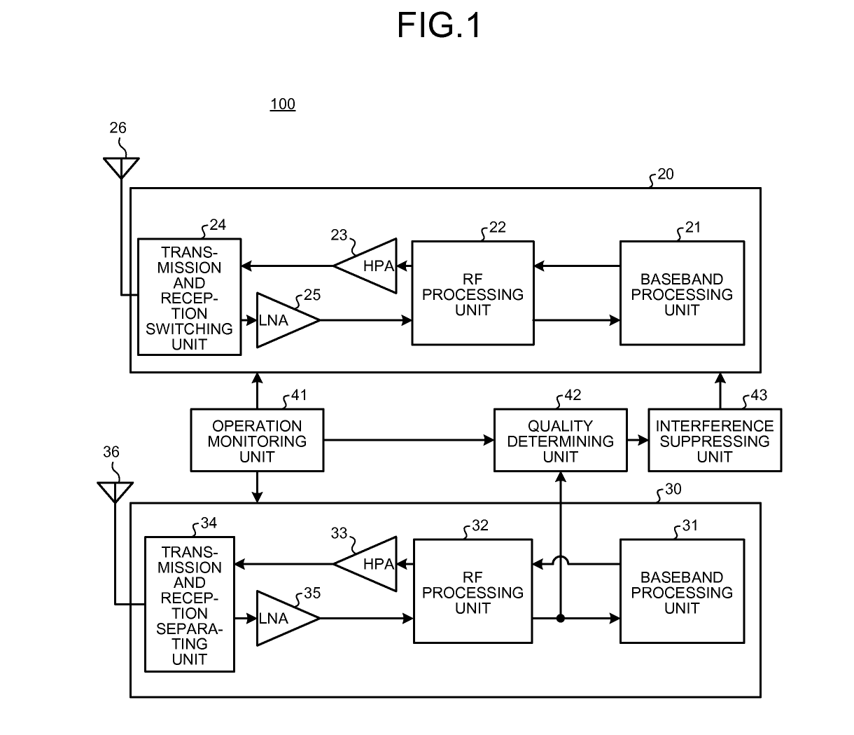

FIG. 1 is a functional block diagram of an exemplary communication terminal in a first embodiment. In FIG. 1, a communication terminal 100 includes a WiMax communication unit 20 that performs a communication according to the WiMax system, a CDMA communication unit 30 that performs a communication according to the CDMA system, an antenna 26, an antenna 36, an operation monitoring unit 41, a quality determining unit 42, and an interference suppressing unit 43.

The WiMax communication unit 20 includes a baseband processing unit 21, a Radio Frequency (RF) process unit 22, a High Power Amplifier (HPA) 23, a transmission and reception switching unit 24, and an LNA 25 so as to perform a WiMax communication.

The baseband processing unit 21 codes and modulates transmission data according to the WiMax system so as to generate a baseband signal, and outputs the generated baseband signal to the RF processing unit 22. The baseband processing unit 21 demodulates and decodes the signal input from the RF processing unit 22 according to the WiMax system so as to obtain the received data.

The RF processing unit 22 performs a digital-analog conversion on the baseband signal input from the baseband processing unit 21 and up-converts the signal so as to output the up-converted signal to the HPA 23. The RF processing unit 22 down-converts the signal input from the LNA 25 and performs an analog-digital conversion on the signal so as to output the converted signal to the baseband processing unit 21.

The HPA 23 amplifies the power of the up-converted signal and outputs the power-amplified signal to the transmission and reception switching unit 24.

The transmission and reception switching unit 24 switches a transmission interval and a reception interval at predetermined time intervals such that the signal input from the HPA 23 is transmitted from the antenna 26 in the transmission interval and the signal received from the antenna 26 is output to the LNA 25 in the reception interval. In other words, the WiMax communication unit 20 performs a communication in Time Division Duplex (TDD).

The LNA 25 amplifies the power of the signal input from the transmission and reception switching unit 24 and outputs the power-amplified signal to the RF processing unit 22.

The CDMA communication unit 30 includes a baseband processing unit 31, an RF processing unit 32, an HPA 33, a transmission and reception separating unit 34, and an LNA 35 so as to perform a CDMA communication.

The baseband processing unit 31 codes and modulates transmission data according to the CDMA system so as to generate a baseband signal, and outputs the generated baseband signal to the RF processing unit 32. The baseband processing unit 31 demodulates and decodes the signal input from the RF processing unit 32 according to the CDMA system so as to obtain the received data.

The RF processing unit 32 performs a digital-analog conversion on the baseband signal input from the baseband processing unit 31 and up-converts the signal so as to output the up-converted signal to the HPA 33. The RF processing unit 32 down-converts the signal input from the LNA 35 and performs an analog-digital conversion on the signal so as to output the converted signal to the baseband processing unit 31 and the quality determining unit 42.

The HPA 33 amplifies the power of the up-converted signal and outputs the power-amplified signal to the transmission and reception separating unit 34.

The transmission and reception separating unit 34 separates the input signals into a transmission signal having a predetermined transmission frequency and a reception signal having a predetermined reception frequency different from the frequency of the transmission frequency. In other words, the transmission and reception separating unit 34 transmits, from the antenna 36, the signal input from the HPA 33 and having a predetermined transmission frequency and outputs, to the LNA 35, the signal received from the antenna 36 and having a predetermined reception frequency. In other words, the CDMA communication unit 30 performs a communication in Frequency Division Duplex (FDD).

The LNA 35 amplifies the power of the signal input from the transmission and reception separating unit 34 and outputs the power-amplified signal to the RF processing unit 32.

The operation monitoring unit 41 monitors whether the WiMax communication unit 20 operates and whether the CDMA communication unit 30 operates, and outputs the monitoring results to the quality determining unit 42. As the monitoring result, one of the following monitoring results 1 to 3 is output to the quality determining unit 42.

Monitoring result 1: Only the WiMax communication unit 20 operates.

Monitoring result 2: Only the CDMA communication unit 30 operates.

Monitoring result 3: Both of the WiMax communication unit 20 and the CDMA communication unit 30 simultaneously operate.

The quality determining unit 42 determines whether the reception quality of the CDMA communication has deteriorated and outputs the determination result to the interference suppressing unit 43 when the monitoring result 3 is input, in other words, when the WiMax communication and the CDMA communication are simultaneously performed. The quality determining unit 42 determines using the signal input from the RF processing unit 32, for example, based on Ec/Io (the ratio of desired wave power Ec to total received power Io) whether the reception quality of the CDMA communication has deteriorated. Specifically, the quality determining unit 42 determines that the reception quality has deteriorated under the influence of an interference signal when the Ec/Io is less than a threshold. The quality determining unit 42 determines that the reception quality has not deteriorated when the Ec/Io is equal to or larger than a threshold. Note that the index indicating the reception quality is not limited to the Ec/Io. In addition to the Ec/Io, for example, Frame Error Rate (FER), Bit Error Rate (BER), the throughput, and the like can be used as the index indicating the reception quality. On the other hand, the quality determining unit 42 does not operate when the monitoring result 1 or the monitoring result 2 is input.

The interference suppressing unit 43 performs a process for suppressing the interference in the CDMA communication or, namely, the interference caused by the WiMax communication (hereinafter, also referred to as an “interference suppressing process”) when the quality determining unit 42 determines that the reception quality has deteriorated, in other words, when the reception quality of the CDMA communication has deteriorated. Specifically, the interference suppressing unit 43 performs a process for stopping the WiMax communication as the interference suppressing process in the first embodiment. In other words, the interference suppressing unit 43 stops the operation of the WiMax communication unit 20 when the reception quality of the CDMA communication has deteriorated. This stops the WiMax communication unit 20 from transmitting signals from the antenna 26.

### Process in Communication Terminal

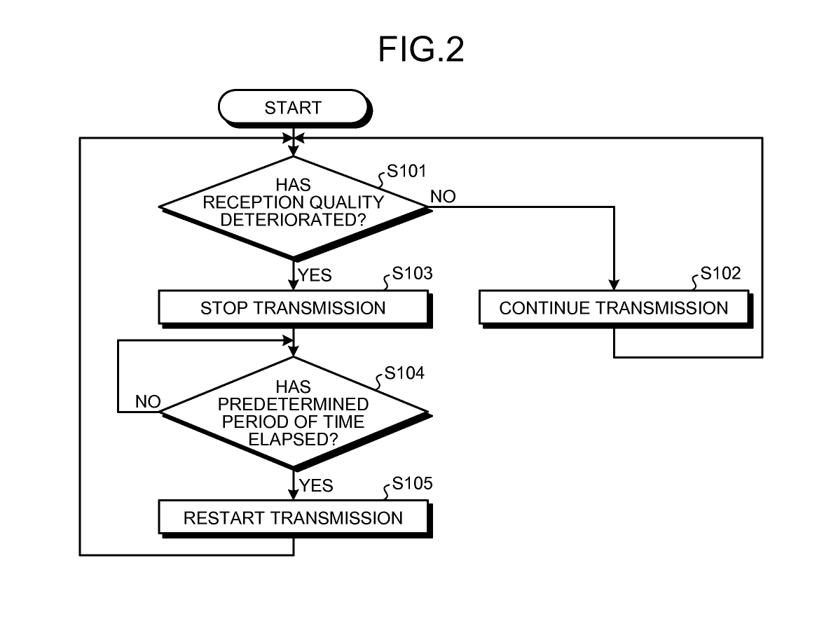

FIG. 2 is a flowchart for describing the process in the communication terminal in the first embodiment.

The quality determining unit 42 determines whether the reception quality of the CDMA communication has deteriorated (step S101).

When the reception quality of the CDMA communication has not deteriorated (step S101: No), the interference suppressing unit 43 does not stop the operation of the WiMax communication unit 20. Thus, the WiMax communication unit 20 continues the transmission (step S102), and the process goes back to step S101.

When the reception quality has deteriorated (step S101: Yes), the interference suppressing unit 43 stops the operation of the WiMax communication unit 20. Thus, the WiMax communication unit 20 stops the transmission (step S103).

While a predetermined period of time has not elapsed after the interference suppressing unit 43 has stopped the operation of the WiMax communication unit 20 (step S104: No), the interference suppressing unit 43 continues stopping the transmission of the WiMax communication unit 20.

When a predetermined period of time has elapsed after the interference suppressing unit 43 has stopped the operation of the WiMax communication unit 20 (step S104: Yes), the interference suppressing unit 43 restarts the operation of the WiMax communication unit 20. Thus, the WiMax communication unit 20 restarts the transmission (step S105). After the restart of the transmission, the process goes back to step S101.

According to the first embodiment, the WiMax communication unit 20 performs the WiMax communication and the CDMA communication unit 30 performs the CDMA communication in the communication terminal 100 as described above. The quality determining unit 42 determines whether the reception quality of the CDMA communication has deteriorated when the WiMax communication and the CDMA communication are simultaneously performed. The interference suppressing unit 43 performs a suppressing process for suppressing the interference in the CDMA communication or, namely, the interference caused by the WiMax communication when the reception quality of the CDMA communication has deteriorated. Specifically, the interference suppressing unit 43 stops the operation of the WiMax communication unit 20 in order to stop the WiMax communication as the interference suppressing process when the reception quality of the CDMA communication has deteriorated. This can stop the signal transmission in the WiMax communication that is the interference in the CDMA communication when the reception quality of the CDMA communication has deteriorated. Thus, the signal transmission in the WiMax communication is stopped when the WiMax communication and the CDMA communication are simultaneously performed in the communication terminal 100 and the reception quality of the CDMA communication has deteriorated. This can prevent the deterioration of the reception quality of the CDMA communication.

### Second Embodiment

In the second embodiment, a process for reducing the power of the baseband signal in the WiMax communication is performed as the interference suppressing process.

### Configuration of Communication Terminal

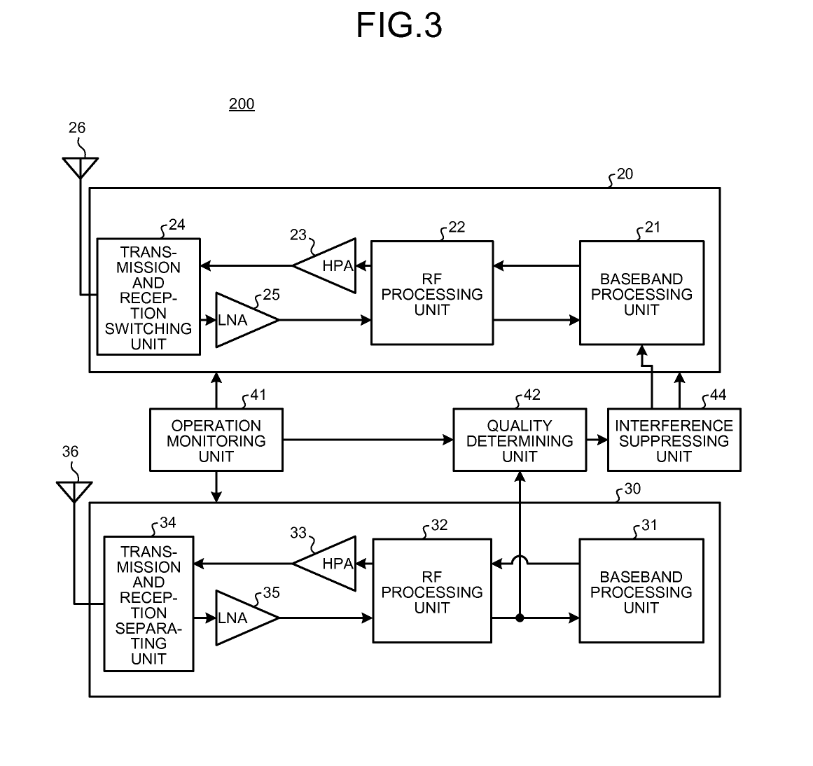

FIG. 3 is a functional block diagram of an exemplary communication terminal in the second embodiment. A communication terminal 200 includes an interference suppressing unit 44 in FIG. 3.

The interference suppressing unit 44 gives the instruction for reducing the power of signals to a baseband processing unit 21 in a WiMax communication unit 20 when a quality determining unit 42 determines that the reception quality has deteriorated, in other words, when the reception quality of the CDMA communication has deteriorated. The baseband processing unit 21 generates a power-reduced baseband signal according to the instruction. This reduces the output level of the baseband signal output from the baseband processing unit 21. Thus, the transmission level of the signal transmitted from an antenna 26 of the WiMax communication unit 20 is reduced. In other words, the interference suppressing unit 44 reduces the transmission level in the WiMax communication by reducing the power of the baseband signal in the WiMax communication unit 20.

### Process in Communication Terminal

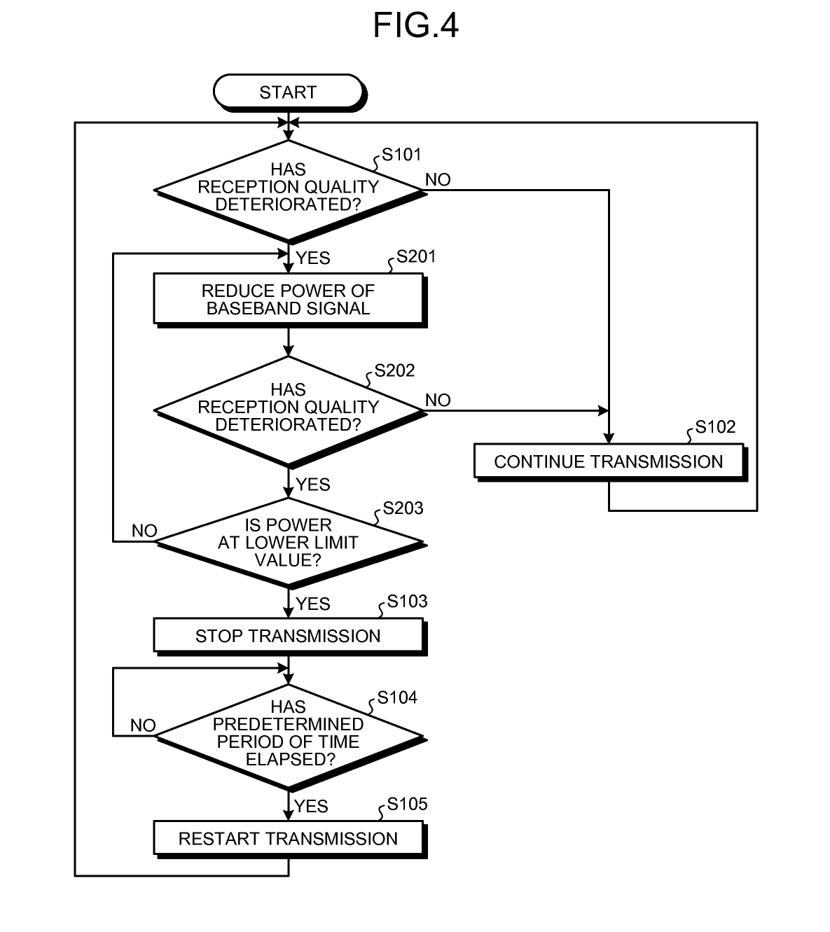

FIG. 4 is a flowchart for describing the process in the communication terminal in the second embodiment.

When the reception quality has deteriorated (step S101: Yes), the interference suppressing unit 44 reduces the power of the baseband signal in the WiMax communication unit 20 (step S201).

The quality determining unit 42 determines whether the reception quality of the CDMA communication has still deteriorated even after the power of the baseband signal has been reduced (step S202).

When the reception quality has not deteriorated (step S202: No), the WiMax communication unit 20 continues the transmission (step S102). The process goes back to step S101.

When the reception quality of the CDMA communication has still deteriorated even after the power of the baseband signal has been reduced (step S202: Yes), the interference suppressing unit 44 determines whether the power of the baseband signal is at the lower limit value (step S203).

When the power of the baseband signal does not reach the lower limit value (step S203: No), the interference suppressing unit 44 further reduces the power of the baseband signal in the WiMax communication unit 20 (step S201).

When the power of the baseband signal reaches the lower limit value (step S203: Yes), the interference suppressing unit 44 stops the operation of the WiMax communication unit 20. This stops the transmission of the WiMax communication unit 20 (step S103).

According to the second embodiment, the interference suppressing unit 44 performs the process for reducing the transmission level in the WiMax communication as the interference suppressing process in the communication terminal 200 as described above when the reception quality of the CDMA communication has deteriorated. This reduces the transmission level of the signal by the WiMax communication that is the interference in the CDMA communication when the reception quality of the CDMA communication has deteriorated. Thus, the level of the interference signal can be suppressed. The deterioration of the reception quality of the CDMA communication can be prevented even when both of the WiMax communication and the CDMA communication are simultaneously performed in the communication terminal 200.

More specifically, the interference suppressing unit 44 reduces the transmission level in the WiMax communication by reducing the power of the baseband signal in the WiMax communication unit 20. Reducing the power of the baseband signal is efficient as an easy interference suppressing process in order to prevent the deterioration of the reception quality due to the cause 2 or the cause 3.

### Third Embodiment

In the third embodiment, a process for reducing the gain of an amplifier is performed as the interference suppressing process.

### Configuration of Communication Terminal

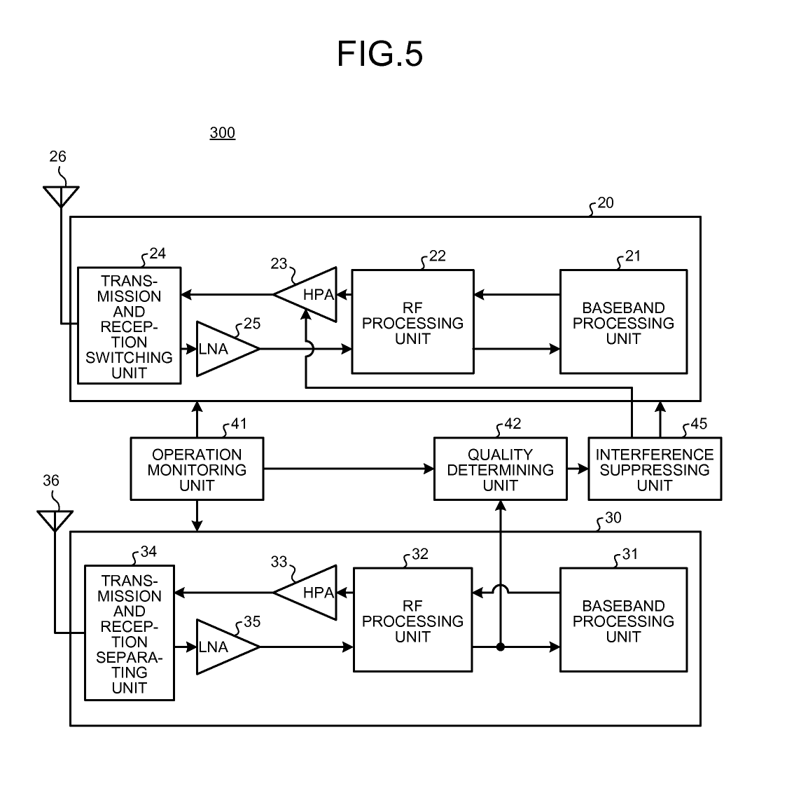

FIG. 5 is a functional block diagram of an exemplary communication terminal in the third embodiment. In FIG. 5, a communication terminal 300 includes an interference suppressing unit 45.

The interference suppressing unit 45 reduces the gain of an HPA 23 in a WiMax communication unit 20 when a quality determining unit 42 determines that the reception quality has deteriorated, in other words, when the reception quality of the CDMA communication has deteriorated. In other words, the interference suppressing unit 45 reduces the transmission level in the WiMax communication by reducing the gain of the HPA 23 included in the WiMax communication unit 20.

### Process in Communication Terminal

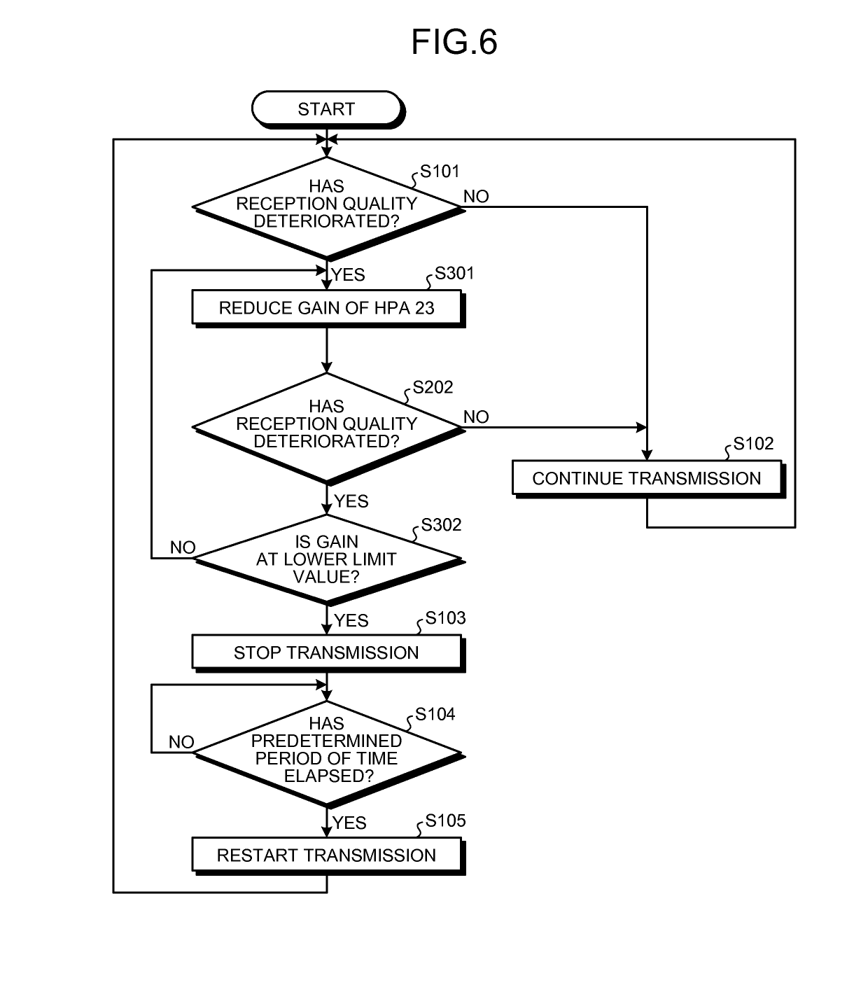

FIG. 6 is a flowchart for describing the process in the communication terminal in the third embodiment.

When the reception quality has deteriorated (step S101: Yes), the interference suppressing unit 45 reduces the gain of the HPA 23 in the WiMax communication unit 20 (step S301).

The quality determining unit 42 determines whether the reception quality of the CDMA communication has still deteriorated even after the gain of the HPA 23 has been reduced (step S202).

When the reception quality has not deteriorated (step S202: No), the WiMax communication unit 20 continues the transmission (step S102). The process goes back to step S101.

When the reception quality has still deteriorated even after the gain of the HPA 23 has been reduced (step S202: Yes), the interference suppressing unit 45 determines whether the gain of the HPA 23 is at the lower limit value (step S302).

When the gain of the HPA 23 does not reach the lower limit value (step S302: No), the interference suppressing unit 45 further reduces the gain of the HPA 23 in the WiMax communication unit 20 (step S301).

When the gain of the HPA 23 reaches the lower limit value (step S302: Yes), the interference suppressing unit 45 stops the operation of the WiMax communication unit 20. This stops the transmission of the WiMax communication unit 20 (step S103).

According to the third embodiment, the interference suppressing unit 45 performs the process for reducing the transmission level in the WiMax communication as the interference suppressing process in the communication terminal 300 as described above when the reception quality of the CDMA communication has deteriorated. This reduces the transmission level of the signal by the WiMax communication that is the interference in the CDMA communication when the reception quality of the CDMA communication has deteriorated. Thus, the level of the interference signal can be suppressed. The deterioration of the reception quality of the CDMA communication can be prevented even when both of the WiMax communication and the CDMA communication are simultaneously performed in the communication terminal 300.

More specifically, the interference suppressing unit 45 reduces the transmission level in the WiMax communication by reducing the gain of the HPA 23 included in the WiMax communication unit 20. The magnitude of the noise in the reception band relates to the magnitude of the gain of the HPA 23. Thus, reducing the gain of the HPA 23 is efficient as an easy interference suppressing process in order to prevent the deterioration of the reception quality due to the cause 2 or the cause 3, and is especially efficient in order to prevent the deterioration of the reception quality due to the cause 1.

### Fourth Embodiment

A communication terminal is used in various environments. For example, the communication terminal is used while the user holds the communication terminal in the user's hand, or the communication terminal is used while being put on a user's arbitrary place. Thus, the characteristics of the antenna of the communication terminal vary depending on the environment in which the communication terminal is used. Further, the antenna gain of each antenna independently varies. Thus, a process for switching the antenna used for transmitting signals among a plurality of antennas is performed as the interference suppressing process in the fourth embodiment.

### Configuration of Communication Terminal

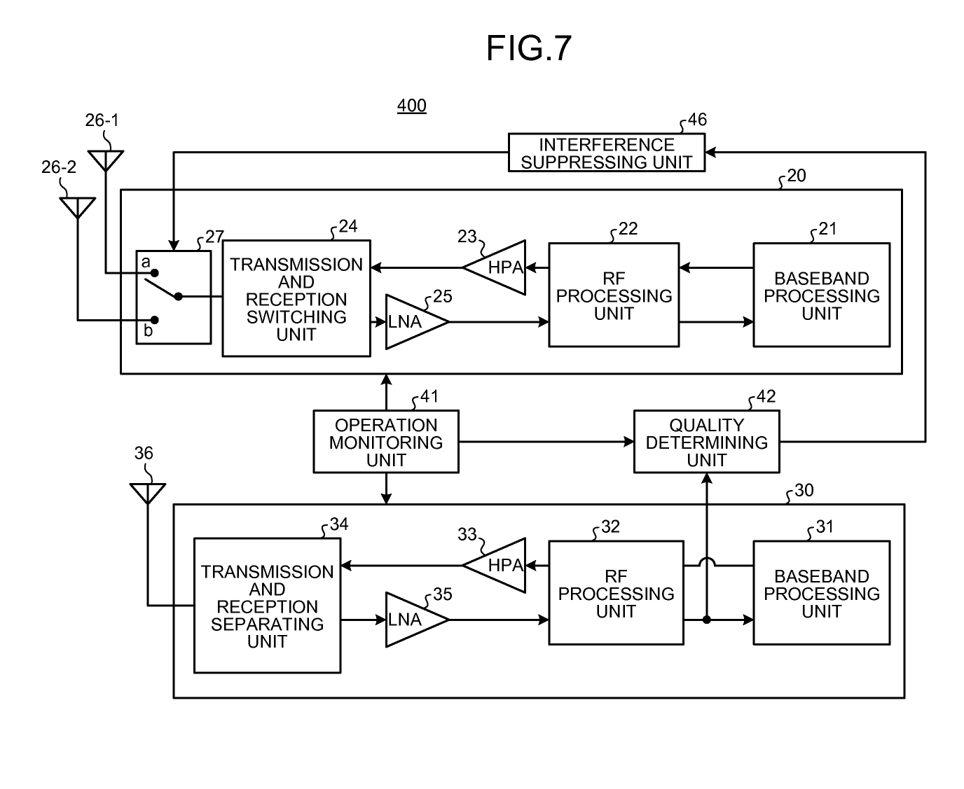

FIG. 7 is a functional block diagram of an exemplary communication terminal in the fourth embodiment. In FIG. 7, a communication terminal 400 includes a switch 27, an antenna 26-1, an antenna 26-2, and an interference suppressing unit 46. The antennas 26-1 and 26-2 are connected to a transmission and reception switching unit 24 through the switch 27.

When the switch 27 is connected to a side a, the signal output from the transmission and reception switching unit 24 is transmitted from the antenna 26-1. On the other hand, when the switch 27 is connected to a side b, the signal output from the transmission and reception switching unit 24 is transmitted from the antenna 26-2.

At that time, a large coupling amount between the antenna of the WiMax communication unit 20 and the antenna of the CDMA communication unit 30 causes the reception quality of the CDMA communication to deteriorate.

Thus, the interference suppressing unit 46 switches the switch 27 on the side a to the side b, or switches the switch 27 on the side b to the side a when the quality determining unit 42 determines that the reception quality has deteriorated. In other words, the interference suppressing unit 46 switches the antenna used for transmitting the signals output from the WiMax communication unit 20 between the antenna 26-1 and the antenna 26-2 when the reception quality of the CDMA communication has deteriorated. This changes the coupling amount between the antenna of the WiMax communication unit 20 and the antenna of the CDMA communication unit 30.

### Process in Communication Terminal

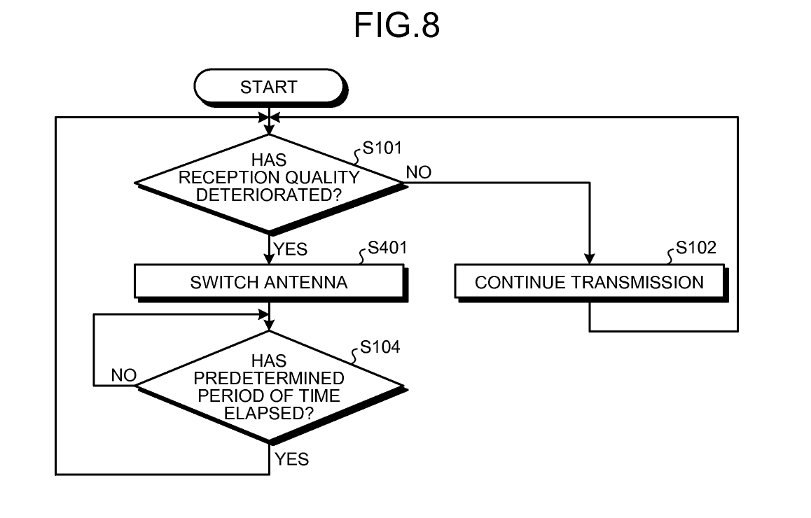

FIG. 8 is a flowchart for describing the process in the communication terminal in the fourth embodiment.

When the reception quality deteriorates (step S101: Yes), the interference suppressing unit 46 switches the antenna used for transmitting the signals output from the WiMax communication unit 20 between the antenna 26-1 and the antenna 26-2 (step S401).

While a predetermined period of time has not elapsed after the antenna has been switched (step S104: No), the interference suppressing unit 46 keeps the antenna switched.

When a predetermined period of time has elapsed after the antenna has been switched (step S104: Yes), the process goes back to step S101.

According to the fourth embodiment, the interference suppressing unit 46 performs the process for switching the antenna used for transmitting the signals output from the WiMax communication unit 20 as the interference suppressing process in the communication terminal 400 as described above when the reception quality of the CDMA communication has deteriorated. This changes the coupling amount between the antenna of the WiMax communication unit 20 and the antenna of the CDMA communication unit 30. For example, the coupling amount between the antenna 26-2 and the antenna 36 is sometimes smaller than the coupling amount between the antenna 26-1 and the antenna 36. In that case, switching the antenna used for the WiMax communication from the antenna 26-1 to the antenna 26-2 reduces the coupling amount between the antenna used for the WiMax communication and the antenna used for the CDMA communication. This can suppress the interference in the CDMA communication from the WiMax communication. Thus, the deterioration of the reception quality of the CDMA communication can be prevented even when both of the WiMax communication and the CDMA communication are simultaneously performed in the communication terminal 400.

### Fifth Embodiment

In the fifth embodiment, a process for switching the frequency band used for the CDMA communication is performed as the interference suppressing process.

### Configuration of Communication Terminal

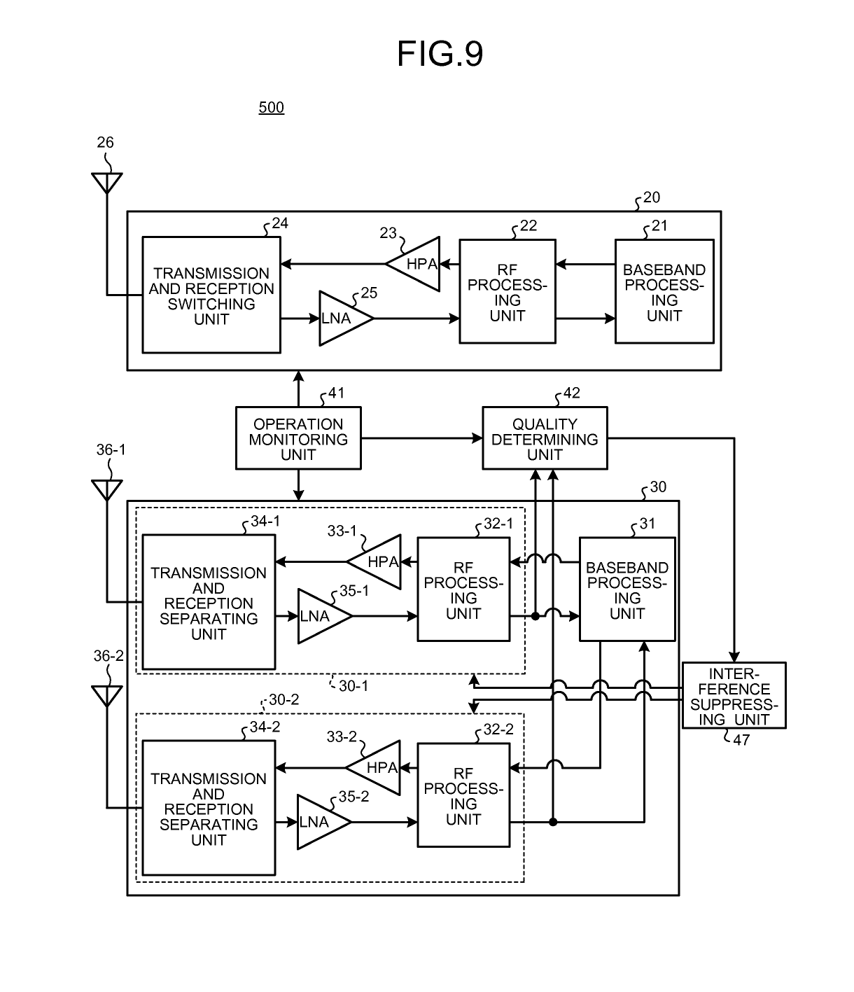

FIG. 9 is a functional block diagram of an exemplary communication terminal in the fifth embodiment. In FIG. 9, a communication terminal 500 can perform the CDMA communication in a plurality of band classes. Herein, the band class means a frequency band used for a communication. For example, 800 MHz band is defined as Band class 0 and 2 GHz band is defined as Band class 6.

The communication terminal 500 includes an interference suppressing unit 47. The CDMA communication unit 30 includes a 2 GHz band communication unit 30-1 and an 800 MHz band communication unit 30-2.

The 2 GHz band communication unit 30-1 includes an RF processing unit 32-1, an HPA 33-1, a transmission and reception separating unit 34-1, and an LNA 35-1 in order to perform a CDMA communication in the 2 GHz band. The 2 GHz band communication unit 30-1 is connected to an antenna 36-1.

The 800 MHz band communication unit 30-2 includes an RF processing unit 32-2, an HPA 33-2, a transmission and reception separating unit 34-2, and an LNA 35-2 in order to perform a CDMA communication in the 800 MHz band. The 800 MHz band communication unit 30-2 is connected to an antenna 36-2.

The RF processing unit 32-1 performs the same process as the RF processing unit 32 does except for up-converting a baseband signal into the frequency in the 2 GHz band. The RF processing unit 32-2 performs the same process as the RF processing unit 32 does except for up-converting a baseband signal into the frequency in the 800 MHz band. The descriptions of the HPAs 33-1 and 33-2, the transmission and reception separating units 34-1 and 34-2, and the LNAs 35-1 and 35-2 are omitted because they perform the same processes as the HPA 33, the transmission and reception separating unit 34, and the LNA 35 do, respectively.

When a quality determining unit 42 determines that the reception quality has deteriorated, the interference suppressing unit 47 stops the operation of the 2 GHz band communication unit 30-1 and starts the operation of the 800 MHz band communication unit 30-2, or stops the operation of the 800 MHz band communication unit 30-2 and starts the operation of the 2 GHz band communication unit 30-1. In other words, the interference suppressing unit 47 switches the frequency band used for the CDMA communication between the 2 GHz band and the 800 MHz band when the reception quality of the CDMA communication has deteriorated.

### Process in Communication Terminal

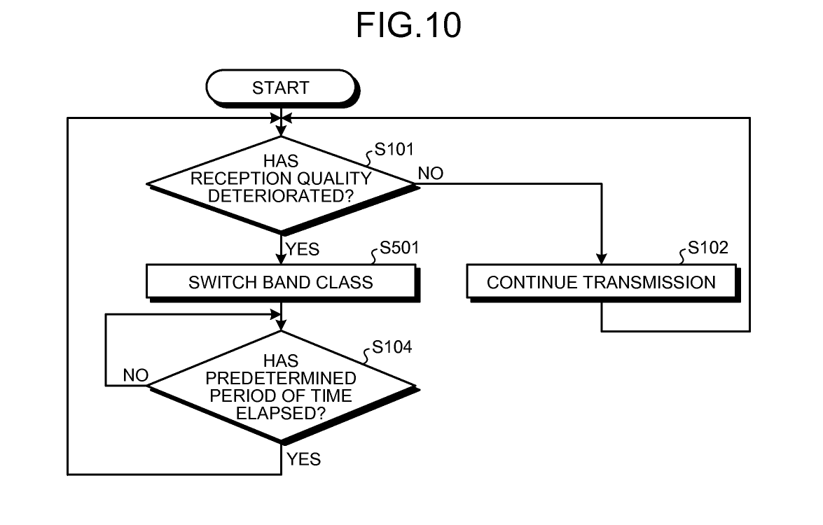

FIG. 10 is a flowchart for describing the process in the communication terminal in the fifth embodiment.

When the reception quality has deteriorated (step S101: Yes), the interference suppressing unit 47 stops one of the operations of the 2 GHz band communication unit 30-1 and the 800 MHz band communication unit 30-2 and starts the operation of the other. In other words, the interference suppressing unit 47 switches the band class between the 2 GHz band and the 800 MHz band (step S501).

While a predetermined period of time has not elapsed after the band class has been switched (step S104: No), the interference suppressing unit 47 keeps the band class switched.

When a predetermined period of time has elapsed after the band class has been switched (step S104: Yes), the process goes back to step S101.

According to the fifth embodiment, the interference suppressing unit 47 performs, as the interference suppressing process, the process for switching the frequency used for the CDMA communication between the 2 GHz band and the 800 MHz band in which the CDMA communication unit 30 can perform a communication in the communication terminal 500 as described above when the reception quality of the CDMA communication has deteriorated. This changes the reception frequency band of the CDMA communication. Switching the frequency band used for the CDMA communication can cause the reception frequency band of the CDMA communication to differ from the transmission frequency band of the WiMax communication. In that case, switching the frequency band used for the CDMA communication reduces the inter modulation distortion components. This can suppress the interference in the CDMA communication from the WiMax communication. Thus, the deterioration of the reception quality of the CDMA communication can be prevented even when both of the WiMax communication and the CDMA communication are simultaneously performed in the communication terminal 500.

### Sixth Embodiment

In the sixth embodiment, a process for switching the path to an antenna for transmission signals between the path without a Band Pass Filter (BPF) and the path through the BPF is performed as the interference suppressing process.

### Configuration of Communication Terminal

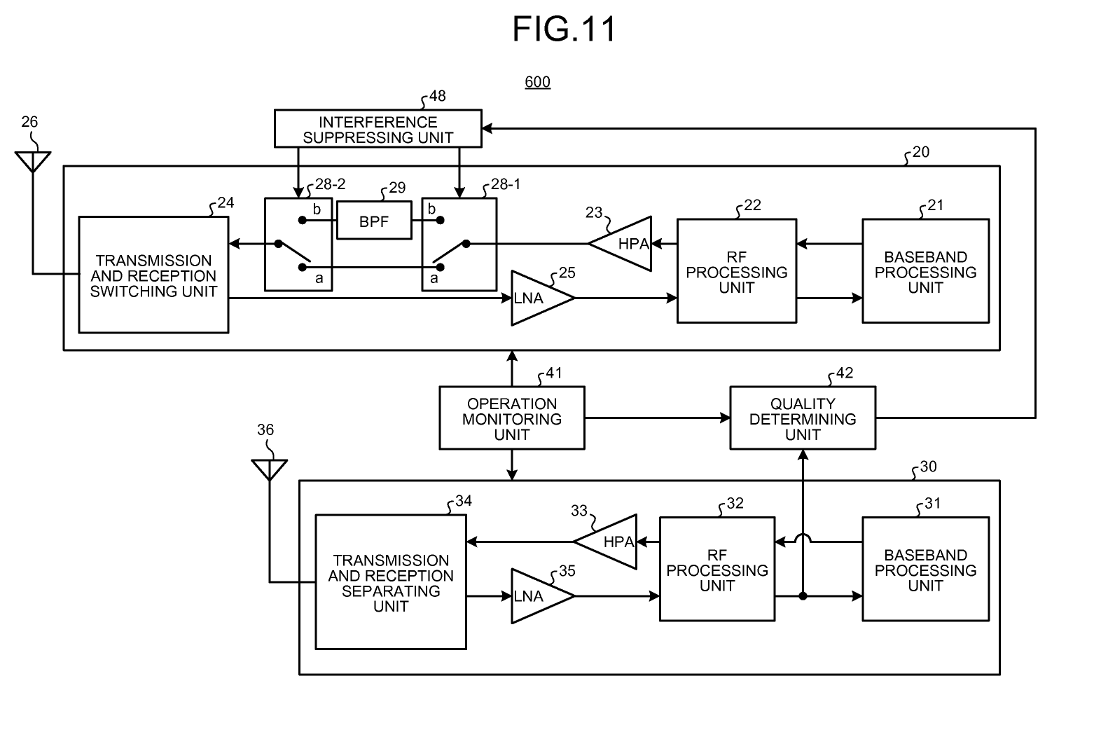

FIG. 11 is a functional block diagram of an exemplary communication terminal in the sixth embodiment. In FIG. 11, a WiMax communication unit 20 in a communication terminal 600 includes a BPF 29, a switch 28-1, and a switch 28-2. When the switch 28-1 and the switch 28-2 are connected to a side b, a signal output from an HPA 23 is input to a transmission and reception switching unit 24 through the BPF 29. On the other hand, when the switch 28-1 and the switch 28-2 are connected to a side a, a signal output from the HPA 23 is input to the transmission and reception switching unit 24 without the BPF 29. As described above, the WiMax communication unit 20 in the sixth embodiment includes the BPF 29 provided at the post-stage of the HPA 23, a first path from the HPA 23 to the antenna 26 through the BPF 29, and a second path from the HPA 23 to the antenna 26 without the BPF 29. The communication terminal 600 further includes an interference suppressing unit 48.

A noise in the reception band due to a transmission signal is mainly caused by the amplification process in the HPA 23. Thus, the BPF 29 filters the signal output from the HPA 23 so as to output only a signal in a predetermined pass band to the transmission and reception switching unit 24. In other words, the BPF 29 performs a process for reducing noises in the reception band of the signals output from the HPA 23.

The interference suppressing unit 48 switches both of the switch 28-1 on the side a and the switch 28-2 on the side a to the sides b a when a quality determining unit 42 determines that the reception quality has deteriorated. In other words, the interference suppressing unit 48 switches the path from the second path without the BPF 29 to the first path through the BPF when the reception quality of the CDMA communication has deteriorated.

### Process in Communication Terminal

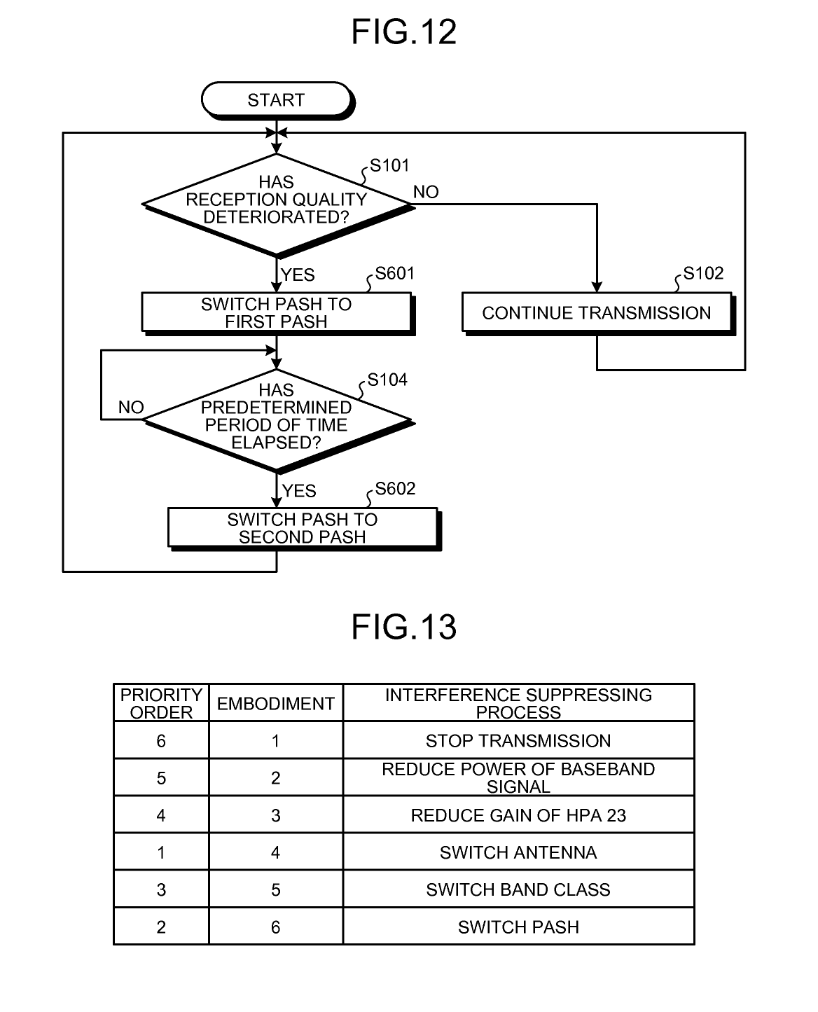

FIG. 12 is a flowchart for describing the process in the communication terminal in the sixth embodiment.

When the reception quality has deteriorated (step S101: Yes), the interference suppressing unit 48 switches the path of the signal output from the HPA 23 from the second path without the BPF 29 to the first path through the BPF 29 by switching the switches 28-1 and 28-2 to the sides b (step S601).

While a predetermined period of time has not elapsed after the path has been switched (step S104: No), the interference suppressing unit 48 keeps the path switched.

When a predetermined period of time has elapsed after the path has been switched (step S104: Yes), the interference suppressing unit 48 switches the path of the signal output from the HPA 23 from the first path through the BPF 29 to the second path without the BPF 29 by switching the switches 28-1 and 28-2 to the sides a (step S602). After the path has been switched to the second path, the process goes back to step S101.

According to the sixth embodiment as described above, the interference suppressing unit 48 uses the second path without the BPF 29 in the communication terminal 600 when the reception quality of the CDMA communication has not deteriorated. On the other hand, the interference suppressing unit 48 uses the first path through the BPF 29 when the reception quality of the CDMA communication has deteriorated. In other words, the interference suppressing unit 48 performs, as the interference suppressing process, a process for switching the path of the signal output from the HPA 23 to the antenna 26 from the second path without the BPF 29 to the first path through the BPF 29 when the reception quality of the CDMA communication has deteriorated. This can reduce the noises in the reception band caused by the signals transmitted from the WiMax communication unit 20 when the reception quality of the CDMA communication has deteriorated. Thus, this can suppress the interference in the CDMA communication from the WiMax communication. Thus, the deterioration of the reception quality of the CDMA communication can be prevented even when both of the WiMax communication and the CDMA communication are simultaneously performed in the communication terminal 600.

### Seventh Embodiment

The seventh embodiment is a combination of the first to sixth embodiments.

Some of the first to sixth embodiments can be appropriately combined and performed. When some of the first to sixth embodiments are combined and performed, they are preferably performed in the order according to the priority. For example, it is desirable to perform a plurality of the embodiments while the embodiments having a larger advantage are given higher priorities. Thus, in the seventh embodiment, a plurality of types of interference suppressing processes described in the first to sixth embodiments and different from each other are performed in the priority order until the deterioration of the reception quality of the CDMA communication is eliminated. Specifically, for example, an interference suppressing unit in the seventh embodiment (not illustrated in the drawings) performs interference suppressing processes in the priority order illustrated in FIG. 13.

FIG. 13 is a view for describing the process in a communication terminal in the seventh embodiment. As described in FIG. 13, the fourth, sixth, fifth, third, second, and first embodiments are set in descending order of priority in that case. The interference suppressing process in each embodiment is as described above. The interference suppressing unit in the seventh embodiment first performs the interference suppressing process in the fourth embodiment when the reception quality of the CDMA communication has deteriorated. When the reception quality of the CDMA communication has still deteriorated even after the interference suppressing process in the fourth embodiment has been performed, the interference suppressing unit in the seventh embodiment next performs the interference suppressing process in the sixth embodiment. After that, the interference suppressing unit in the seventh embodiment similarly performs the interference suppressing processes in the fifth, third, second, and first embodiments in sequence until the deterioration of the reception quality of the CDMA communication is eliminated.

Herein, the advantage of the interference suppressing process in each of the embodiments will be described. Each of the interference suppressing processes in the second to sixth embodiments has an advantage in that the transmission is not interrupted because the transmission in the WiMax communication is not stopped. Each of the interference suppressing processes in the first, and fourth to sixth embodiments has an advantage in that the throughout of the WiMax communication is not reduced because the transmission level of the WiMax communication is not reduced. Each of the interference suppressing processes in the first to fourth, and sixth embodiments has an advantage in that the communication area for the CDMA communication is not limited even when only a specific band class can be used depending on the area. Each of the interference suppressing processes in the first to fifth embodiments has an advantage in that the power loss caused by passing through the BPF 29 does not occur. The priority order is set in consideration of the comparison of the greatness of the advantages in FIG. 13.

Note that, although the combination of all of the first to sixth embodiments has been described above as an example, some of the first to sixth embodiments can appropriately be combined and performed.

As described above, a plurality of types of interference suppressing processes different from each other are performed in sequence according to the priority order in the seventh embodiment until the deterioration of the reception quality of the CDMA communication is eliminated. This can sequentially perform the types of interference suppressing processes in ascending order of disadvantage. Thus, the interference suppressing processes can efficiently be implemented.

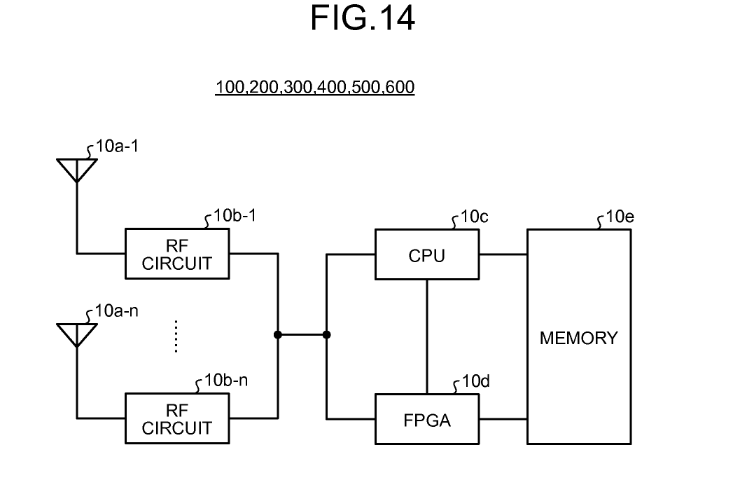

### Other Embodiments

[1] The communication terminals 100 to 600 in the first to sixth embodiments can be implemented with the following hardware configuration. FIG. 14 is a view of an exemplary hardware configuration of a communication terminal. As described in FIG. 14, each of the communication terminals 100, 200, 300, 400, 500, and 600 includes antennas 10a-1 to 10a-n, RF circuits 10b-1 to 10b-n, a Central Processing Unit (CPU) 10c, a Field Programmable Gate Array (FPGA) 10d, and a memory 10e as the hardware configuration. The memory 10e includes, for example, a RAM such as an SDRAM, a ROM, and a flash memory. The antennas 26, 36, 26-1, 26-2, 36-1, and 36-2 are implemented with the antennas 10a-1 to 10a-n. The baseband processing units 21 and 31, the operation monitoring unit 41, the quality determining unit 42, and the interference suppressing units 43, 44, 45, 46, 47, and 48 are implemented with the CPU 10c or the FPGA 10d, and the memory 10e. The RF processing units 22, 32, 32-1, and 32-2, the HPAs 23, 33, 33-1, and 33-2, and the LNAs 25, 35, 35-1, and 35-2, the transmission and reception switching unit 24, the transmission and reception separating units 34, 34-1, and 34-2, the switches 27, 28-1, and 28-2, and the BPF 29 are implemented with the RF circuits 10b-1 to 10b-n.

[2] Each process described above can also be implemented by executing a previously prepared program with the CPU. For example, programs corresponding to the processes performed with the operation monitoring unit 41, the quality determining unit 42, and the interference suppressing units 43, 44, 45, 46, 47, and 48 are previously stored in a memory such that each of the programs can be read to the CPU in order to function as a process. Each of the programs does not have to always be stored in the memory in advance. In other words, for example, each of the programs can be stored in a transportable recording medium such as a flexible disk (FD), a CD-ROM, an MO disk, a DVD disk, a magnet-optical disk, an IC card, or a memory card that is capable of accessing each of the communication terminals 100 to 600 such that each of the programs can be read to the CPU in order to function as a process. Further, for example, each of the programs is previously stored in a computer, a server, or the like connected to each of the communication terminals 100 to 600 through a wired or wireless connection such as the Internet, a LAN, or a WAN such that each of the programs can be read to the CPU in order to function as a process.

An aspect disclosed herein can prevent deterioration of the reception quality even when communications using a plurality of communication systems are simultaneously performed in a communication terminal.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication terminal comprising:
a first communication unit that performs a first communication using a first communication system;
a second communication unit that performs a second communication using a second communication system different from the first communication system;
a determining unit that determines whether a reception quality of the second communication deteriorates when the first communication and the second communication are simultaneously performed; and
a suppressing unit that, when the reception quality deteriorates, performs a suppressing process for suppressing an interference in the second communication, the interference being caused by the first communication.

2. The communication terminal according to claim 1,
wherein the suppressing unit performs a process for stopping the first communication as the suppressing process.

3. The communication terminal according to claim 1,
wherein the suppressing unit performs a process for reducing a transmission level in the first communication as the suppressing process.

4. The communication terminal according to claim 3,
wherein the suppressing unit reduces the transmission level by reducing power of a baseband signal in the first communication unit.

5. The communication terminal according to claim 3,
wherein the suppressing unit reduces the transmission level by reducing a gain of an amplifier included in the first communication unit.

6. The communication terminal according to claim 1, further comprising a plurality of antennas connected to the first communication unit,
wherein the suppressing unit performs a process for switching an antenna used for transmitting a signal output from the first communication unit among the plurality of antennas as the suppressing process.

7. The communication terminal according to claim 1,
wherein the second communication unit enables a communication in a plurality of frequency bands, and
the suppressing unit performs a process for switching an frequency band used for the second communication among the plurality of frequency bands as the suppressing process.

8. The communication terminal according to claim 1,
wherein the first communication unit includes:
an amplifier;
a band pass filter provided at the post-stage of the amplifier;
a first path from the amplifier to an antenna through the band pass filter; and
a second path from the amplifier to the antenna without the band pass filter, and
the suppressing unit performs a process for switching a path from the second path to the first path as the suppressing process.

9. The communication terminal according to claim 1,
wherein the suppressing unit performs a plurality of types of the suppressing processes different from each other in sequence according to a priority order until the deterioration of the reception quality is eliminated.

10. A communication method in a communication terminal in which both of a first communication using a first communication system and a second communication using a second communication system different from the first communication system are enabled, the communication method comprising:
determining whether a reception quality of the second communication deteriorates when the first communication and the second communication are simultaneously performed; and
performing, when the reception quality deteriorates, a suppressing process for suppressing an interference in the second communication, the interference being caused by the first communication.
